(19) United States
(12) Patent Application Publication
(10) Pub. No.: US 2001/0026630 A1
(43) Pub. Date: Oct. 4, 2001

(54) Moving image reception quality evaluation apparatus

(76) Inventor: Yoshizou Honda, Kanagawa (JP)

Correspondence Address: Fish & Richardson P.C., Suite 2800, 45 Rockefeller Plaza, New York, NY, 10111, US

(21) Appl. No.: 09/813,682

(22) Filed: Mar. 21, 2001

(30) Foreign Application Priority Data
Mar. 28, 2000 (JP) P. 2000-089828

(51) Int. Cl. G06K 9/00

(52) U.S. Cl. 382/107

(57) ABSTRACT

A moving image reception quality evaluation apparatus has a moving image code reception section 101 for receiving the same moving image code branched by a branch unit 50 as the moving image code input to a moving image receiver 20 just before the moving image receiver 20 receives the moving image code, a moving image decoder section 102 having an equivalent function to a moving image decoder section 202 for decoding the moving image code in the moving image receiver 20 and detecting an anomaly of the moving image code, an image quality degradation evaluation section 103 for analyzing output of the moving image decoder section 102 and evaluating the image quality, and a transmission section 104 for transmitting the evaluation result to the outside.

### BACKGROUND OF THE INVENTION

1. Field of the Invention

This invention relates to an image quality evaluation apparatus in moving image communications and in particular to a moving image reception quality evaluation apparatus for evaluating the quality of a moving image at the reception time after the moving image is transmitted.

2. Description of the Related Art

The international standards of digital moving image code (simply, moving image code) are, for example, MPEG (Moving Picture Experts Group)-2 (ISO/IEC-13818) and MPEG-4 (ISO/IEC-14496) according to ISO (International Organization for Standardization) and IEC (International Electrotechnical Commission) and H.261, H263, etc., according to ITU (International Telecommunication Union) Recommendations. Throughout the specification, unless otherwise noted, the moving image code refers to the moving image code conforming to the international standards or is also applied to the moving image code equivalent to the coding systems used in the international standards.

The digital moving image is a continuous arrangement of instantaneous pictures called frames, and each frame consists of digital data representing color, brightness, or gradation values of a large number of points called pixels into which a display screen is disassembled like a lattice.

The above-mentioned moving image code is represented as a continuous bit string provided by compressing the original digital moving image information. It may be called a stream. Generally, the moving image has a large information amount and thus less important information is omitted and information that can be represented by a smaller number of bits is replaced. For example, such a format in which data delimiters are omitted to avoid frequent occurrences and instead as the stream is read from the beginning, the number of bits of the following data is clarified is predetermined. For example, when 60 seven-bit data pieces are followed and then 30 13-bit data pieces are followed, if delimiters are inserted, 360 bits (=60×4 bits+30×4 bits) are inserted assuming the delimiter length is four bits. However, if data pieces are arranged following the numeric values representing the number of bits and the number of data pieces, it is sufficient to assign about 10 to 30 bits.

However, a transmission error, data discard, a delay, or the like occurs in transmission and a loss occurs at a midpoint on the received stream. In this case, the number of bits of the following data becomes unclear or the data having a different number of bits appears just after. If the number of bits is unclear as in the former case, decoding is impossible and is stopped. In the latter case, the data pieces are not delimited based on the correct number of bits for decoding and thus a numeric value that cannot occur in the stipulation is obtained and the corresponding image cannot be decoded or a gradation value different from that of the original image is output.

In most moving image codes described above, to decrease the adverse effect caused by such a transmission error, etc., a continuation of notable bits is inserted intentionally in the range in which the compression ratio does not become high. It is called resynchronous code, etc. This means that if the stream is decoded in order by a decoder and the number of bits, etc., becomes unclear at a midpoint, as the stream is advanced and resynchronous code is encountered, correct decoding can be executed again starting at the bits, which is called “recovering lost synchronization.” For example, if resynchronous code is inserted into a point where a new frame is started, even if out-of-synchronization occurs in the preceding frame, synchronization is recovered at the following frame. Resynchronous code may be used at more fine points.

The decoder for decoding moving image code comprises a function of recovering synchronization. That is, the decoder comprises a function of detecting an out-of-synchronization condition and in many cases, outputs the condition as a decode error.

Since a part of the image cannot correctly be decoded as a result of occurrence of out-of-synchronization, some decoders have a function of copying, for example, the image at equal position in the immediately preceding frame into the corresponding image area and decoding and outputting as an alternative image for making the error visually inconspicuous. This function is called concealment function.

In addition to the out-of-synchronization condition, an anomaly in the received stream is detected because a transmission delay occurs, namely, a predetermined number of frames are not received for a predetermined time. Alternatively, a method of detecting a transmission error itself using error check code or error correction code to deal with the transmission error is also available.

A single stream of moving image code contains not only code directly related to the gradation values of the pixels, but also code representing the moving image code type, format, and version and code representing the digital moving image specifications of the screen size (the number of vertical pixels and the number of horizontal pixels), the number of frames per unit time, color representation system, etc. If such information cannot correctly be decoded accidentally due to a transmission error, etc., a situation wherein most of the image is impaired can occur.

If most of a frame cannot be decoded due to a transmission error or decoding is not in time for displaying a frame because of a delay, processing of stopping decoding and display of the frame and making a transition to decoding of the following frame may be performed. In seeing display, the current frame does not change to a new frame and thus motion seems to stop. This phenomenon is called freeze, or may be called display skip because the corresponding frame is skipped to the following frame.

A prediction coding method is available as a method used with the moving image code described above. In the prediction coding method, based on the statistical nature of numeric values, already decoded values before one point of the stream is decoded are used and as the following data, the difference from the numeric value provided by prediction by a determined calculation method is coded into the stream. The method uses the fact that although the decoded data change width is large and the number of bits cannot be shortened, if the change width of the difference from the prediction value is small, the number of bits to be coded into the stream may be short. Also in this case, if the previously decoded numeric value is not correct, the next data to be decoded becomes incorrect. Therefore, a transmission error or a loss at one point may affect other points one after another.

If prediction code is much used, the compression ratio tends to become high, but the adverse effect of a transmission error on the image tends to grow. In this case, the prediction code relation is terminated at one point and prediction is again executed at the next point.

As described above, the effect of a transmission error on quality degradation of a decoded image varies depending on which information in the stream is impaired and further depends on resynchronous code of the moving image code specifications and the termination of prediction. The moving image code specifications generally can be selected by an encoder and even the same decoder often can correctly decode moving image codes under several different specifications. Since occurrence of a transmission error cannot be forecasted more than the statistical nature and it is difficult to derive the reception quality of a moving image from selecting the moving image code specifications, it is indispensable to quantitatively evaluate the reception quality after actual moving images are transmitted and received.

Hitherto, for example, the main portion of “moving image communication quality determination apparatus” in Japanese Patent Application No. Hei 11-153078 by the present inventor has corresponded to a moving image quality evaluation apparatus for evaluating the image quality in communication using this kind of moving image code.

The correspondence portion relevant to the description of the invention will be discussed briefly below for easy comparison with the configuration of the invention.

FIG. 5 is a block diagram to show a configuration example of a moving image quality determination apparatus in the related art. In the figure, a moving image transmitter 30 transmits moving image code to a moving image reception quality evaluation apparatus 60 through a network 40. The moving image reception quality evaluation apparatus 60 contains a moving image receiver 20 for receiving the moving image code transmitted by the moving image transmitter 30. The moving image receiver 20 has atypical moving image reception function and a typical moving image transmission function and comprises a moving image code reception section 200 for receiving the moving image code, a moving image decoder section 202 for decoding the moving image code received at the moving image code reception section 200, and a display section 203 for displaying the moving image provided by the moving image decoder section 202.

The moving image reception quality evaluation apparatus 60 further includes an image quality degradation evaluation section 103 and a transmission section 104.

The moving image code reception section 200 outputs the received moving image code to the image quality degradation evaluation section 103. Either the moving image code reception section 200 or the moving image decoder section 202 outputs the following signals described in (1) to (7) to the image quality degradation evaluation section 103:

(1) Point of an anomaly caused by a transmission error of apart of received moving image code and its detection signal;

(2) point of an anomaly caused by discard of a part of received moving image code during transmission and its detection signal;

(3) point of an anomaly caused by a transmission delay of apart of received moving image code and its detection signal;

(4) point of an anomaly caused by stipulation violation of a part of received moving image code and its detection signal;

(5) concealment correction point of moving image decoder and its occurrence signal;

(6) point where decoding is restarted based on resynchronous code after decoding becomes impossible because of the above-mentioned anomaly, and its occurrence signal; and

(7) signal indicating the area of an image which becomes abnormal from the above-mentioned anomaly to restart.

The image quality degradation evaluation section 103 uses the signals in (1) to (7) to locate the abnormal image area in pixel units, block units, frame units and calculates the area ratio on the image. Alternatively, the image quality degradation evaluation section 103 uses the signals in (1) to (7) and calculates the ratio between the square sum of the gradation values of the image after concealment correction on the abnormal image area and the square sum of the gradation values of the whole decoded image described above.

The image quality degradation evaluation section 103 outputs the point, the area ratio, and the square sum ratio of the abnormal image area to the transmission section 104 as image quality evaluation values.

The transmission section 104 transmits the image quality evaluation values in response to an output request via the network 40.

According to the mechanism of the moving image communications described above, the image quality evaluation function is added to the typical moving image reception function, whereby the image quality evaluation values of the received moving image can be known.

As described above, in the related art example, the moving image receiver and the moving image reception quality evaluator are integrated into a moving image reception terminal and therefore there is a problem of increasing the processing amount of the moving image reception terminal. This problem becomes a large problem if the terminal is a mobile terminal as described below.

The moving image receivers are of various sizes from a desk-top terminal being always installed at the same position for receiving moving images for use to small-sized mobile terminals for receiving moving images for use, such as mobile communication terminals and portable terminals.

The mobile terminal needs to be frequently moved from one installation place to another, to be carried to different places for use, or to receive moving images for use while moving and thus is restricted in points of carryable weight and size and no communication cable and no power cable. With no communication cable, communication means uses infrared ray or radio wave. With no power cable, a small battery supplies power.

Generally, the data amount in moving image communications and the processing amount required for communications and decode display are extraordinarily large as compared with voice communications. This factor is also one of the causes of delaying widespread use of mobile moving image receivers as compared with voice-dedicated mobile receivers (so-called portable telephones).

Typically, the transmission amount of voice used for conversation on a portable telephone is several kbits/s after compression, while the transmission amount of a moving image considered to be necessary for conversation on a portable video telephone is several ten kbits/s to several Mbits/s after compression. As the transmission amount is enlarged, image quality degradation caused by compression distortion is lessened. To provide the image quality equivalent to that of television broadcast, the transmission amount is several Mbits/s after compression.

Therefore, the processing amount required for an image terminal in general applications is 10 to 1000 times the processing amount of a voice terminal. Even taking 1000 times as an example, the image quality becomes equal to that of commonplace television broadcast and thus barely reaches the image quality demanded by a large number of users.

However, speeding up the processing amount in such a terminal generally results in upsizing the circuit scale or upsizing a battery because power consumption grows as electronic devices are speeded up. This leads to upsizing or an increase in the weight of a mobile terminal to be moved from one place to another.

Thus, the terminals are used in allowable limits of the requirement level of the image quality because of the restriction on the terminal size.

Under the circumstances surrounding the mobile terminals, in the moving image reception quality evaluation apparatus in the related art contains, the moving image receiving terminal contains the moving image reception quality evaluation processing function and thus further the image quality level is lowered or the terminal is upsized and is increased in weight because of the restriction on the processing amount; this is a problem.

If the image quality level is lowered, the original quality of the image received by the moving image receiver cannot be evaluated.

### SUMMARY OF THE INVENTION

It is therefore an object of the invention to provide a moving image reception quality evaluation apparatus that can evaluate the reception quality of a moving image without increasing the processing amount of a moving image receiver as a mobile terminal.

To the end, according to a first aspect of the invention, there is provided a moving image reception quality evaluation apparatus for evaluating the quality of a moving image at the receiving time of a moving image receiver for receiving moving image code output from a moving image transmitter through a network, the moving image reception quality evaluation apparatus comprising moving image code reception means for receiving the same moving image code branched as the moving image code input to the moving image receiver just before the moving image receiver receives the moving image code, moving image decoding means having an equivalent function to means for decoding the moving image code that the moving image receiver has and detecting an anomaly of the moving image code, and image quality evaluation means for analyzing output of the moving image decoding means and evaluating the image quality, characterized in that the moving image code received by the moving image receiver can be input from the moving image receiver to the moving image decoding means.

According to the first aspect of the invention, the moving image reception quality evaluation apparatus comprises moving image code reception means for receiving the same moving image code branched as the moving image code input to a moving image receiver just before the moving image receiver receives the moving image code, moving image decoding means having an equivalent function to means for decoding the moving image code that the moving image receiver has and detecting an anomaly of the moving image code, and image quality evaluation means for analyzing output of the moving image decoding means and evaluating the image quality, characterized in that the moving image code received by the moving image receiver can be input from the moving image receiver to the moving image decoding means. Thus, the moving image reception quality can be evaluated with the processing amount of the moving image receiver little increased.

According to a second aspect of the invention, there is provided a moving image reception quality evaluation apparatus for evaluating the quality of a moving image at the receiving time of a moving image receiver for receiving moving image code output from a moving image transmitter through a network, the moving image reception quality evaluation apparatus comprising moving image code reception means for receiving the same moving image code branched as the moving image code input to the moving image receiver just before the moving image receiver receives the moving image code, moving image decoding means having an equivalent function to means for decoding the moving image code that the moving image receiver has and detecting an anomaly of the moving image code, and image quality evaluation means for analyzing output of the moving image decoding means and evaluating the image quality.

According to the second aspect of the invention, the moving image reception quality evaluation apparatus comprises moving image code reception means for receiving the same moving image code branched as the moving image code input to a moving image receiver just before the moving image receiver receives the moving image code, moving image decoding means having an equivalent function to means for decoding the moving image code that the moving image receiver has and detecting an anomaly of the moving image code, and image quality evaluation means for analyzing output of the moving image decoding means and evaluating the image quality. Thus, the moving image reception quality can be evaluated without changing the configuration of the moving image receiver, namely, without increasing the processing amount of the moving image receiver.

According to a third aspect of the invention, there is provided a moving image reception quality evaluation apparatus for evaluating the quality of a moving image at the receiving time of a moving image receiver for receiving moving image code output from a moving image transmitter through a network, the moving image reception quality evaluation apparatus comprising moving image decoding means having an equivalent function to means for decoding the moving image code that the moving image receiver has and detecting an anomaly of the moving image code, the moving image decoding means for receiving the moving image code received by the moving image receiver from the moving image receiver, decoding the moving image code, and detecting an anomaly of the moving image code, and image quality evaluation means for analyzing output of the moving image decoding means and evaluating the image quality.

According to the third aspect of the invention, the moving image reception quality evaluation apparatus comprises moving image decoding means having an equivalent function to means for decoding the moving image code that a moving image receiver has and detecting an anomaly of the moving image code, the moving image decoding means for receiving the moving image code received by the moving image receiver from the moving image receiver, decoding the moving image code, and detecting an anomaly of the moving image code, and image quality evaluation means for analyzing output of the moving image decoding means and evaluating the image quality. Thus, the moving image reception quality can be evaluated without remarkably increasing the processing amount simply by adding a transfer processing section of moving image code to moving image reception section.

According to a fourth aspect of the invention, there is provided a moving image reception quality evaluation apparatus for evaluating the quality of a moving image at the receiving time of a moving image receiver for receiving moving image code output from a moving image transmitter through a network, the moving image reception quality evaluation apparatus comprising a moving image receiver emulator section for emulating functions equivalent to moving image code reception means and moving image decoding means that a plurality of types of moving image receivers have in response to the type of moving image receiver, and image quality evaluation means for analyzing output of the moving image receiver emulator section and evaluating the reception image qualities of a plurality of types of moving image receivers.

According to the fourth aspect of the invention, the moving image reception quality evaluation apparatus comprises a moving image receiver emulator section for emulating functions equivalent to moving image code reception means and moving image decoding means that a plurality of types of moving image receivers have in response to the type of moving image receiver, and image quality evaluation means for analyzing output of the moving image receiver emulator section and evaluating the reception image qualities of a plurality of types of moving image receivers. Thus, the moving image reception quality evaluation apparatus that can evaluate the moving image reception quality without increasing the processing amount of the moving image receiver can be provided corresponding to a plurality of types of moving image receivers.

Particularly, when most of the moving image reception function is software processing, if an environment equivalent to the software running environment exists under the same OS (operating system), the moving image reception quality evaluation apparatus that can evaluate the moving image reception quality without increasing the processing amount of the moving image receiver can be provided simply by copying and installing the moving image reception software.

### BRIEF DESCRIPTION OF THE DRAWINGS

In the accompanying drawings:

FIG. 1 is a block diagram to show the configuration of a moving image reception quality evaluation apparatus according to a first embodiment of the invention;

FIG. 2 is a block diagram to show the configuration of a moving image reception quality evaluation apparatus according to a second embodiment of the invention;

FIG. 3 is a block diagram to show the configuration of a moving image reception quality evaluation apparatus according to a third embodiment of the invention;

FIG. 4 is a block diagram to show the configuration of a moving image reception quality evaluation apparatus according to a fourth embodiment of the invention; and

FIG. 5 is a block diagram to show the configuration of a moving image reception quality evaluation apparatus in a related art.

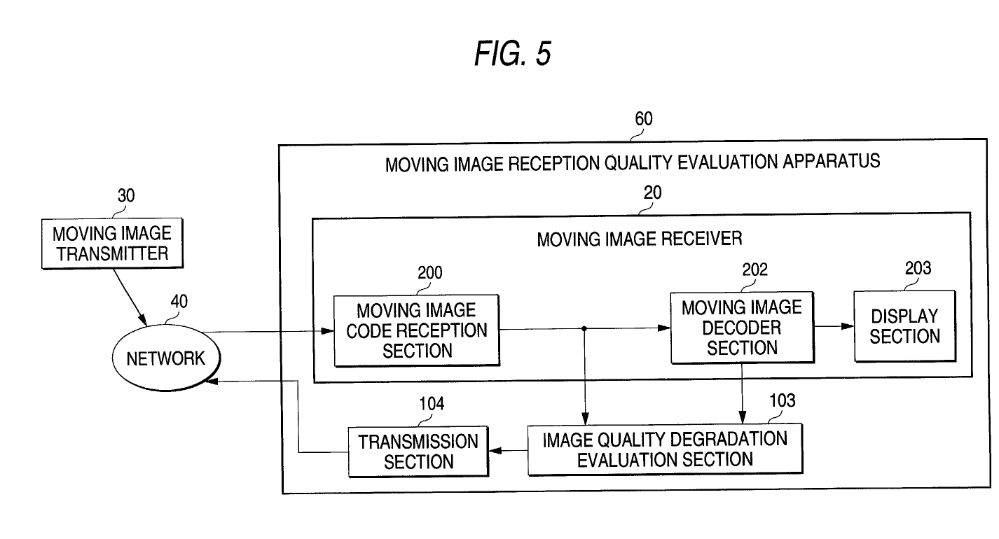

### DETAILED DESCRIPTION OF THE PREFERRED EMBODIMENTS

Referring now to the accompanying drawings, there are shown preferred embodiments of the invention.

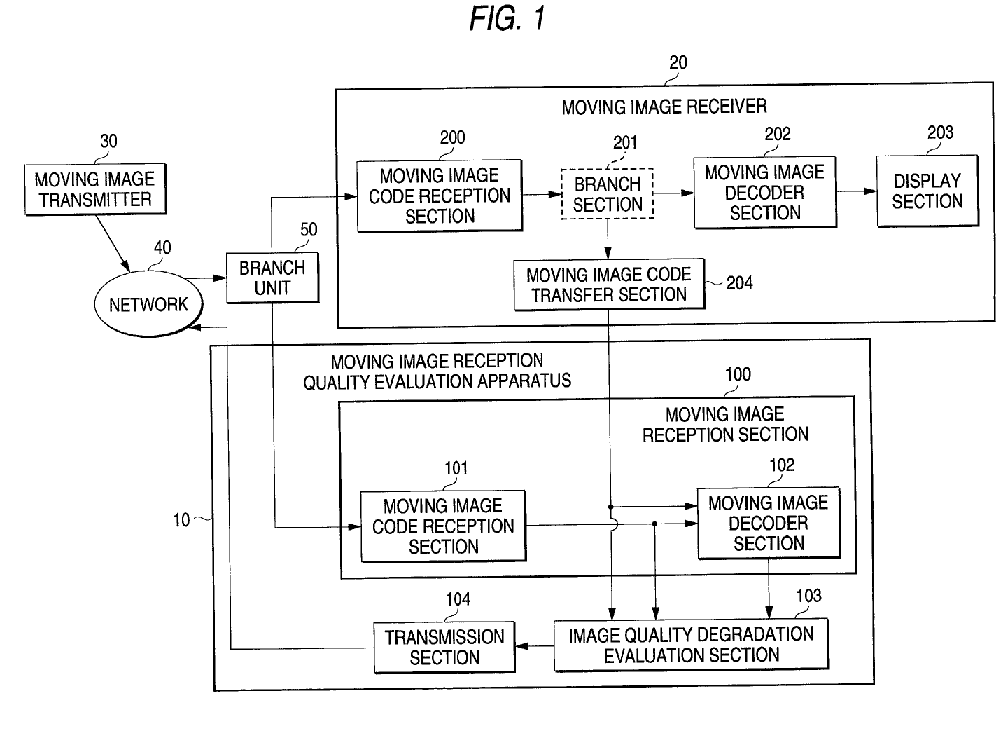

FIG. 1 shows the configuration of a moving image reception quality evaluation apparatus according to a first embodiment of the invention. In the figure, a moving image receiver 20 comprises a moving image code reception section 200 for receiving moving image code sent from a moving image transmitter 30 through a network 40 and a branch unit 50, a branch section 201 for branching output of the moving image code reception section 200 and outputting the moving image code, a moving image decoder section 202 for decoding the moving image code output from one output terminal of the branch section 201 and detecting an anomaly of the moving image code, a display section 203 for displaying a moving image based on decode output provided by the moving image decoder section 202, and a moving image code transfer section 204 for outputting the moving image code output from the other output terminal of the branch section 201 to a moving image reception quality evaluation apparatus 10.

The moving image reception quality evaluation apparatus 10 according to the embodiment of the invention for evaluating the quality of a moving image at the receiving time of the moving image receiver 20 for receiving moving image code output from the moving image transmitter 30 through the network 40 comprises a moving image code reception section 101 for receiving the same moving image code branched by the branch unit 50 as the moving image code input to the moving image receiver 20 just before the moving image receiver 20 receives the moving image code, a moving image decoder section 102 having an equivalent function to the moving image decoder section 202 for decoding the moving image code in the moving image receiver 20 and detecting an anomaly of the moving image code, an image quality degradation evaluation section 103 for analyzing output of the moving image decoder section 102 and evaluating the image quality, and a transmission section 104 for transmitting the evaluation result to the outside.

The moving image code reception section 101 and the moving image decoder section 102 make up a moving image reception section 100. The branch unit 50 has an input terminal connected to the network 40 for inputting the moving image code sent from the moving image transmitter 30. The branch unit 50 has one output terminal connected to the moving image receiver 20 for relaying the moving image code and has the other output terminal connected to the moving image reception quality evaluation apparatus 10 for relaying the same moving image code.

A position where the effect of a transmission error, discard, a delay, etc., of the moving image code can be assumed to be sufficiently small between the branch unit 50 and the moving image receiver 20 is selected as the insertion point of the branch unit 50 and under the circumstance, the moving image reception quality evaluation apparatus 10 evaluates the image quality equivalent to the reception quality of the moving image in the moving image receiver 20 as described later.

The moving image code received by the moving image receiver 20 can be input from the moving image code transfer section 204 in the moving image receiver 20 to the moving image decoder section 102.

The moving image code reception section 101 corresponds to moving image code reception means of the invention, the moving image decoder section 102 corresponds to moving image decoding means of the invention, and the image quality degradation evaluation section 103 corresponds to image quality evaluation means of the invention.

In the described configuration, the moving image transmitter 30 transmits moving image code to the moving image receiver 20 through the network 40.

In the moving image transmitter 20, the moving image code reception section 200 receives the moving image code sent from the moving image transmitter 30, takes out the moving image code, and outputs the moving image code to the branch section 201. The moving image code reception section 200 also outputs a detection signal of a transmission error, discard, or a delay to the branch section 201. The moving image code is input from one output terminal of the branch section 201 to the moving image decoder section 202, which then decodes the input moving image code and outputs the decode result to the display section 203, which then displays the provided moving image. The moving image code reception section 200, the moving image decoder section 202, and the display section 203 are conventional functions of any moving image receiver.

The moving image code and the above-described detection signal concerning evaluation of the reception image quality are output from the other output terminal of the branch section 201 through the moving image code transfer section 204 to the moving image decoder section 102 and the image quality degradation evaluation section 103.

In the moving image reception quality evaluation apparatus 10, the moving image reception section 100 receives the moving image code relayed from the output terminal of the branch unit 50 at the moving image code reception section 101 and takes out and outputs the moving image code. This operation is equivalent to the above-described moving image code reception section 200. The moving image code reception section 101 detects a transmission error, discard, or a delay of the moving image code and outputs its detection signal to the image quality degradation evaluation section 103.

The moving image code output from the moving image code reception section 101 is input to the moving image decoder section 102, which then detects an anomaly of the moving image code. In fact, a function equivalent to the above-described moving image decoder section 202 is provided and decoded image data may not be displayed, but is output to the image quality degradation evaluation section 103. Further, using output of a decode error of the moving image decoder section 102, a decode error signal is output to the image quality degradation evaluation section 103 and a point where decoding is resynchronized from the out-of-synchronization point of decoding is detected and is output to the image quality degradation evaluation section 103. Further, if a concealment function occurs, an occurrence signal, its correction area information, and the post-corrected image are output to the image quality degradation evaluation section 103.

If the moving image code is input to the moving image decoder section 102 only from the moving image code reception section 101, the reception image quality of the moving image in the moving image receiver 20 can be evaluated, but the moving image code may be input from the moving image code transfer section 204 for evaluating the reception image quality of the moving image in the moving image receiver 20. If even a slight difference exists between the reception state of the moving image receiver 20 and that of the moving image reception quality evaluation apparatus 10, the image quality is evaluated based on the moving image code from the moving image code transfer section 204, whereby the moving image reception quality in the moving image receiver 20 can be evaluated more accurately.

The image quality degradation evaluation section 103 inputs decoded image, decode error, out-of-synchronization image area information, concealment occurrence signal, and its image area information of the moving image decoder section 102, transmission error, discard, or delay detection signal of the moving image code reception section 101, and transmission error, discard, or delay detection signal from the moving image code transfer section 204, locates the abnormal area in which the image is impaired, and calculates the size ratio between normal and abnormal areas in pixel units, block units, frame units as an image quality evaluation value. Alternatively, the image quality degradation evaluation section 103 uses the signals and calculates the ratio between the square sum of the gradation values of the image after undergoing concealment correction in the abnormal image area and the square sum of the gradation values of the whole decoded image described above as an image quality evaluation value. The image quality is quantitatively evaluated and time change is recorded.

Each image quality evaluation value of the image quality degradation evaluation section 103 is output to the network 40 through the transmission section 104 in response to an output request.

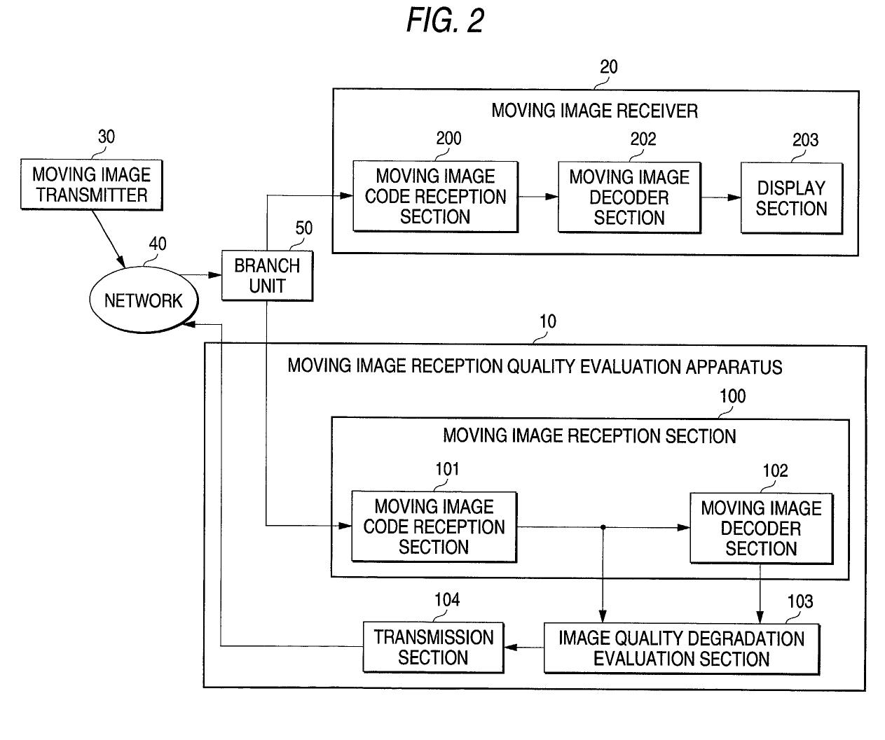

Next, FIG. 2 shows the configuration of a moving image reception quality evaluation apparatus according to a second embodiment of the invention. The moving image reception quality evaluation apparatus according to the second embodiment differs in configuration from the moving image reception quality evaluation apparatus according to the first embodiment previously described with reference to FIG. 1 in that it inputs moving image code only through a branch unit 50, thereby eliminating the need for the branch section 201 and the moving image code transfer section 204 in the moving image reception section 20 in the first embodiment. Components identical with those previously described with reference to FIG. 1 are denoted by the same reference numerals in FIG. 2 and will not be discussed again.

According to the moving image reception quality evaluation apparatus according to the second embodiment of the invention, a moving image reception section 20 can be made up of only a moving image code reception section 200, a moving image decoder section 202, and a display section 203, so that the conventional function of any moving image receiver may be used and the reception quality of a moving image in the moving image receiver can be evaluated without any modifications. Therefore, in the case where the moving image receiver 20 is a terminal attaching importance to miniaturization, to evaluate the reception quality of a moving image in the mobile terminal not allowing any slightly added function because of design of paring down the processing amount, the moving image reception quality evaluation apparatus according to the second embodiment shown in FIG. 2 is fitted.

The function and reception characteristic of a moving image code reception section 101 are made equivalent to those of the moving image code reception section 200 and the decoding characteristic and function of a moving image decoder section 102 are made equivalent to those of the moving image decoder section 202, whereby evaluation equivalent to that of the reception quality of a moving image in the moving image receiver 20 can be executed. That is, the moving image code reception section and the moving image decoder section are provided with a microprogram operating in an integrated circuit or a signal processor, software running under an OS (operating system), or the like commercially available in large quantities, so that equivalent function and performance can be easily provided by using the same commercially available products. Therefore, the moving image reception quality evaluation apparatus can evaluate the moving image reception quality equivalent to the quality of the moving image received by the moving image receiver 20.

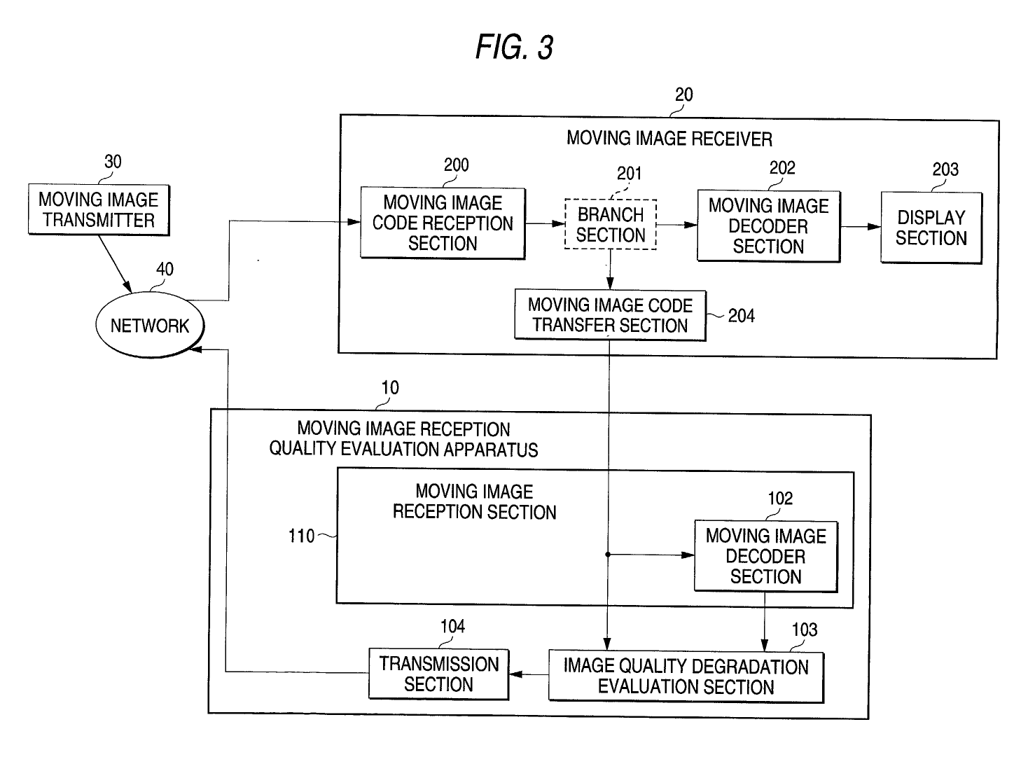

Next, FIG. 3 shows the configuration of a moving image reception quality evaluation apparatus according to a third embodiment of the invention. The moving image reception quality evaluation apparatus according to the third embodiment differs in configuration from the moving image reception quality evaluation apparatus according to the first embodiment previously described with reference to FIG. 1 in that it inputs moving image code only through a moving image code transfer section 204 in a moving image receiver 20, thereby eliminating the need for the branch unit 50 and the moving image code reception section 101 in the first embodiment. Components identical with those previously described with reference to FIG. 1 are denoted by the same reference numerals in FIG. 3 and will not be discussed again.

According to the moving image reception quality evaluation apparatus according to the third embodiment of the invention, the moving image receiver 20 and the moving image reception quality evaluation apparatus share the reception function through a moving image code reception section 200, so that the following advantages are provided: If the moving image receiver 20 is a radio terminal, separate reception sections would differ in radio wave or infrared ray state even slightly, and accurate reception quality match cannot be provided. However, in the moving image reception quality evaluation apparatus according to the third embodiment shown in FIG. 3, even if the moving image receiver 20 is a radio terminal, the reception qualities accurately match on principle because the reception function is shared.

Since only the function of a branch section 201 and the function of the moving image code transfer section 204 are added to the moving image reception function in the moving image receiver in the related art, the reception quality of a moving image in the moving image receiver can be evaluated without remarkably increasing the data processing amount.

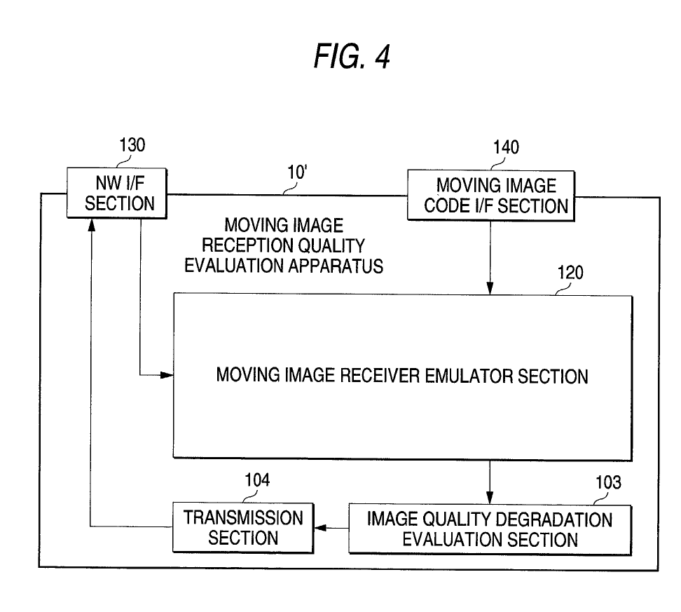

Next, FIG. 4 shows the configuration of a moving image reception quality evaluation apparatus according to a fourth embodiment of the invention. In FIG. 4, the configuration of only the moving image reception quality evaluation apparatus is taken out. The embodiment assumes that a plurality of types of moving image receivers whose reception quality is to be evaluated exist and the reception quality is evaluated in a common configuration as much as possible.

The moving image reception quality evaluation apparatus 10′ according to the embodiment comprises a moving image receiver emulator section 120 for emulating equivalent functions to moving image code reception sections and moving image decoder sections that a plurality of types of moving image receivers have in response to the type of moving image receiver, an image quality degradation evaluation section 103 as image quality evaluation means for analyzing output of the moving image receiver emulator section 120 and evaluating the reception image qualities of a plurality of types of moving image receivers, and a transmission section 104.

The moving image reception quality evaluation apparatus 10′ further includes a network interface (NW I/F) section 130 in a part for receiving moving image code from a line or a network and a moving image code interface (I/F) section 140 in a part for inputting the moving image code transferred from each moving image receiver.

In the described configuration, when the type of moving image receiver 20 whose reception quality is to be evaluated is changed, if the network interface section 130 or the moving image code interface section 140 is replaced with the corresponding specifications and the moving image receiver emulator section 120 changes to that corresponding to equivalent characteristic and function to those of the moving image receiver 20, the moving image reception quality evaluation apparatus 10 previously described with reference to FIG. 1 is applied and the reception quality is evaluated. The moving image reception quality evaluation apparatus using the common configuration for evaluating can be realized by replacing in response to the type of moving image receiver 20. It can be easily realized by matching combination of integrated circuit, processor, operating system, software, etc., as described above.

According to the first aspect of the invention, the moving image reception quality evaluation apparatus comprises moving image code reception means for receiving the same moving image code branched as the moving image code input to a moving image receiver just before the moving image receiver receives the moving image code, moving image decoding means having an equivalent function to means for decoding the moving image code that the moving image receiver has and detecting an anomaly of the moving image code, and image quality evaluation means for analyzing output of the moving image decoding means and evaluating the image quality, characterized in that the moving image code received by the moving image receiver can be input from the moving image receiver to the moving image decoding means. Thus, the moving image reception quality can be evaluated with the processing amount of the moving image receiver little increased.

According to the second aspect of the invention, the moving image reception quality evaluation apparatus comprises moving image code reception means for receiving the same moving image code branched as the moving image code input to a moving image receiver just before the moving image receiver receives the moving image code, moving image decoding means having an equivalent function to means for decoding the moving image code that the moving image receiver has and detecting an anomaly of the moving image code, and image quality evaluation means for analyzing output of the moving image decoding means and evaluating the image quality. Thus, the moving image reception quality can be evaluated without changing the configuration of the moving image receiver, namely, without increasing the processing amount of the moving image receiver.

According to the third aspect of the invention, the moving image reception quality evaluation apparatus comprises moving image decoding means having an equivalent function to means for decoding the moving image code that a moving image receiver has and detecting an anomaly of the moving image code, the moving image decoding means for receiving the moving image code received by the moving image receiver from the moving image receiver, decoding the moving image code, and detecting an anomaly of the moving image code, and image quality evaluation means for analyzing output of the moving image decoding means and evaluating the image quality. Thus, the moving image reception quality can be evaluated without remarkably increasing the processing amount simply by adding a transfer processing section of moving image code to moving image reception section.

According to the fourth aspect of the invention, the moving image reception quality evaluation apparatus comprises a moving image receiver emulator section for emulating functions equivalent to moving image code reception means and moving image decoding means that a plurality of types of moving image receivers have in response to the type of moving image receiver, and image quality evaluation means for analyzing output of the moving image receiver emulator section and evaluating the reception image qualities of a plurality of types of moving image receivers. Thus, the moving image reception quality evaluation apparatus that can evaluate the moving image reception quality without increasing the processing amount of the moving image receiver can be provided corresponding to a plurality of types of moving image receivers.

Particularly, when most of the moving image reception function is software processing, if an environment equivalent to the software running environment exists under the same OS (operating system), the moving image reception quality evaluation apparatus that can evaluate the moving image reception quality without increasing the processing amount of the moving image receiver can be provided simply by copying and installing the moving image reception software.

What is claimed is:

1. A moving image reception quality evaluation apparatus for evaluating the quality of a moving image at the receiving time of a moving image receiver for receiving moving image code output from a moving image transmitter through a network, said apparatus comprising:
a moving image code reception section adapted to receive the same moving image code branched as the moving image code input to the moving image receiver just before the moving image receiver receives the moving image code;
a moving image decoder having an equivalent function to means for decoding the moving image code that the moving image receiver has and detecting an anomaly of the moving image code; and
an image quality evaluation section adapted to analyze output of said moving image decoder and evaluate the image quality;
wherein the moving image code received by the moving image receiver can be input from the moving image receiver to said moving image decoder.

2. A moving image reception quality evaluation apparatus for evaluating the quality of a moving image at the receiving time of a moving image receiver for receiving moving image code output from a moving image transmitter through a network, said apparatus comprising:
a moving image code reception section adapted to receive the same moving image code branched as the moving image code input to the moving image receiver just before the moving image receiver receives the moving image code;
a moving image decoder having an equivalent function to means for decoding the moving image code that the moving image receiver has and detecting an anomaly of the moving image code; and
an image quality evaluation section adapted to analyze the output of said moving image decoder and evaluating the image quality.

3. A moving image reception quality evaluation apparatus for evaluating the quality of a moving image at the receiving time of a moving image receiver for receiving moving image code output from a moving image transmitter through a network, said apparatus comprising:
a moving image decoder having an equivalent function to means for decoding the moving image code that the moving image receiver has and detecting an anomaly of the moving image code, said moving image decoder adapted to receive the moving image code received by the moving image receiver from the moving image receiver, decoding the moving image code, and detecting an anomaly of the moving image code; and
an image quality evaluation section adapted to analyze the output of the moving image decoding means and evaluate the image quality.

4. A moving image reception quality evaluation apparatus for evaluating the quality of a moving image at the receiving time of a moving image receiver for receiving moving image code output from a moving image transmitter through a network, said apparatus comprising:
a moving image receiver emulator section for emulating functions equivalent to moving image code reception means and moving image decoding means that a plurality of types of moving image receivers have in response to the type of moving image receiver; and
an image quality evaluation section adapted to analyze the output of the moving image receiver emulator section and evaluate the reception image qualities of a plurality of types of moving image receivers.
